(19) United States
(12) Patent Application Publication
(10) Pub. No.: US 2026/0076281 A1
(43) Pub. Date: Mar. 19, 2026

(54) ARRANGEMENT FOR OPERATING A HYDRAULIC CONTROL VALVE FOR AN AGRICULTURAL TRACTOR

(71) Applicant: Deere & Company, Moline, IL (US)

(72) Inventors: Manuel Billich, Dornstadt (DE); Sebastian Traut, Landau (DE)

(21) Appl. No.: 19/298,289

(22) Filed: Aug. 13, 2025

(30) Foreign Application Priority Data
Sep. 16, 2024 (EP) 24200514.8

(51) Int. Cl. A01B 63/10; A01B 63/108

(52) U.S. Cl. CPC A01B 63/1013; A01B 63/108

(57) ABSTRACT

An arrangement for operating a hydraulic control valve for an agricultural tractor includes a first hydraulic connection and a second hydraulic connection of the hydraulic control valve alternately acting as a feed line or return line for hydraulic fluid depending on an operating command, a first and second hydraulic coupler for operating a hydraulic consumer attachable thereon, and a 3/2-way valve selectively connects the first hydraulic connection to a working chamber of a hydraulic cylinder in a first switching position and to the first hydraulic coupler in a second switching position, wherein the second hydraulic connection is connected directly to the second hydraulic coupler.

### FIELD OF THE DISCLOSURE

The disclosure relates to an arrangement for operating a hydraulic control valve of an agricultural tractor.

This application claims priority to European Patent Application No. 24200514.8, filed September 16, 2024, which is hereby incorporated by reference.

### BACKGROUND

Agricultural tractors are equipped with a plurality of hydraulic control valves or SCVs (Selective Control Valves). Various implements can be connected to the hydraulic system of the agricultural tractor via the SCVs. An operator of the agricultural tractor can adjust the valve positions of the SCVs.

### SUMMARY

According to an aspect of the present disclosure, an arrangement for operating a hydraulic control valve for an agricultural tractor includes a first hydraulic connection and a second hydraulic connection of the hydraulic control valve alternately acting as a feed line or return line for hydraulic fluid depending on an operating command, a first and second hydraulic coupler for operating a hydraulic consumer attachable thereon, and a 3/2-way valve selectively connects the first hydraulic connection to a working chamber of a hydraulic cylinder in a first switching position or to the first hydraulic coupler in a second switching position, wherein the second hydraulic connection is connected directly to the second hydraulic coupler.

According to an aspect of the present disclosure, the hydraulic cylinder is designed as single-action.

According to an aspect of the present disclosure, the hydraulic cylinder is part of a hydraulic lifting mechanism of a front power lifter.

According to an aspect of the present disclosure, the hydraulic cylinder is designed as double-action, and wherein a further working chamber of the hydraulic cylinder is directly connected to the second hydraulic connection.

According to an aspect of the present disclosure, the hydraulic cylinder is part of a front loader.

According to an aspect of the present disclosure, the 3/2-way valve is designed as electrically actuable.

According to an aspect of the present disclosure, the 3/2-way valve is designed as mechanically actuable.

According to an aspect of the present disclosure, an agricultural tractor includes the arrangement of any of the preceding embodiments.

The above and other features will become apparent from the following detailed description and accompanying drawings.

### BRIEF DESCRIPTION OF THE DRAWINGS

The arrangement according to the disclosure for operating a hydraulic control valve for an agricultural tractor will be described in more detail below on the basis of the appended drawings. Corresponding components or those with comparable function are identified by the same reference signs. In the figures:

FIG. 1 shows a first design of a schematically illustrated example embodiment of the arrangement according to the disclosure for operating a hydraulic control valve for an agricultural tractor; and

FIG. 2 shows a second design of a schematically illustrated example embodiment of the arrangement according to the disclosure for operating a hydraulic control valve for an agricultural tractor.

### DETAILED DESCRIPTION

The embodiments or implementations disclosed in the above drawings and the following detailed description are not intended to be exhaustive or to limit the present disclosure to these embodiments or implementations.

Agricultural tractors are typically equipped with a plurality of hydraulic control valves or SCVs (Selective Control Valves), which are assembled in a control valve block in the rear and/or front area of the agricultural tractor and enable greatly varying hydraulic consumers to be supplied. The hydraulic consumers connected to the control valve block are, for example, part of an attachment or auxiliary device attachable to the agricultural tractor and are used there to execute operating and/or working functions specific for the relevant attachment or auxiliary device. To put the respective hydraulic consumer into operation, the valve position of the hydraulic control valve can be set by an operator via an operator terminal provided in the agricultural tractor.

There is often the wish to operate more than one hydraulic consumer at the same hydraulic control valve because of economic considerations or due to structural restrictions. This is the case, for example, if, in addition to a hydraulic consumer designed as a hydraulic cylinder, which is used to actuate a front power lift or a front loader on the agricultural tractor, in addition a hydraulic function of an attachment or auxiliary device attached to the agricultural tractor is to be executed. The hydraulic consumer provided for executing the hydraulic function is designed, for example, as a hydraulic motor or hydraulic actuator.

Different solutions are known for precluding simultaneous actuation of the two hydraulic consumers and also the mutual influencing thereof. These are usually based on the use of comparatively complex way valves, which are located both in a feed line and a return line of the hydraulic control valve and which permit a selective selection between the two hydraulic consumers, or as a compromise enable an interruption of the hydraulic connection to only one of the two hydraulic consumers so as not to impair the operation of the other hydraulic consumer. A further routine possibility is to connect feed line and return line of the hydraulic control valve via a T-piece to first and second hydraulic coupler pairs, which are located at different points of the agricultural tractor, wherein exclusively the respective one of the two hydraulic consumers to be operated is connected to one of the hydraulic coupler pairs. The solutions known in this regard are therefore either technically complex or inconvenient to handle.

In view of this, there is a need for an improved option for operating two different hydraulic consumers on a common hydraulic control valve.

This object is achieved by an arrangement for operating a hydraulic control valve for an agricultural tractor having the features of one or more embodiments disclosed herein.

The arrangement according to the disclosure for operating a hydraulic control valve for an agricultural tractor comprises a hydraulic control valve, which has a first or second hydraulic connection alternately acting as a feed line or return line for hydraulic fluid depending on an operating command, a first and second hydraulic coupler for operating a hydraulic consumer connectable thereto, and a 3/2-way valve, by means of which the first hydraulic connection can be connected either to a working chamber of a hydraulic cylinder or to the first hydraulic coupler, wherein the second hydraulic connection is connected directly to the second hydraulic coupler.

The arrangement according to the disclosure is based on the observation or finding that for the case that two hydraulic consumers independent of one another are to be operated via a common hydraulic control valve, one of the hydraulic consumers is usually a hydraulic cylinder (spatially) associated with the agricultural tractor. This is generally part of a front loader for adjusting a loader arm or a loading tool (such as a loading scoop or fork) or a hydraulic lift mechanism, comprised by a front power lifter, for raising and lowering associated lower links. Under such circumstances, it is sufficient to arrange a single 3/2-way valve between the first hydraulic connection and working chamber of the hydraulic cylinder, since the hydraulic cylinder is blocked with respect to movement upon interruption of the hydraulic connection thus established due to the hydraulic fluid enclosed in the working chamber. The hydraulic cylinder therefore adopts an inactive state in which exclusively an actuation of the second hydraulic consumer is released.

Advantageous refinements of the arrangement according to the disclosure can be found in one or more embodiments disclosed herein.

In a first embodiment of the arrangement according to the disclosure, it can be provided that the hydraulic cylinder is designed as single-action. This is typically the case in front power lifters of agricultural tractors, in which two hydraulic cylinders for raising and lowering associated lower links having working chambers connected in parallel are typically provided as part of a hydraulic lifting mechanism.

Notwithstanding this, in a second embodiment of the arrangement according to the disclosure the hydraulic cylinder can also be designed as double-action, wherein a further working chamber of the hydraulic cylinder is directly connected to the second hydraulic connection. The double-action hydraulic cylinder is, for example, part of a front loader attached to the agricultural tractor and is used therein to adjust a loader arm or a loading tool in the form of a loading scoop or fork.

To enable convenient switching between the two hydraulic consumers via an operator terminal located in a driver's platform of the agricultural tractor, it can be provided that the 3/2-way valve is designed as electrically actuable by means of an electromagnetic positioning element at the behest of a supervision unit connected to the operator terminal. Notwithstanding this, the 3/2-way valve can also be designed as mechanically actuable and can have means for manual actuation in the form of an operating lever or the like.

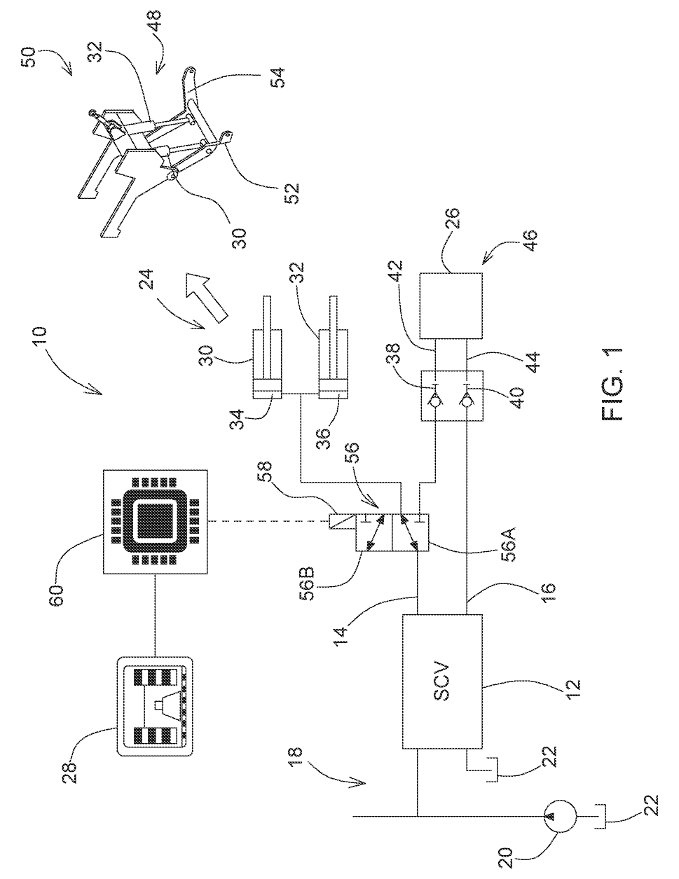

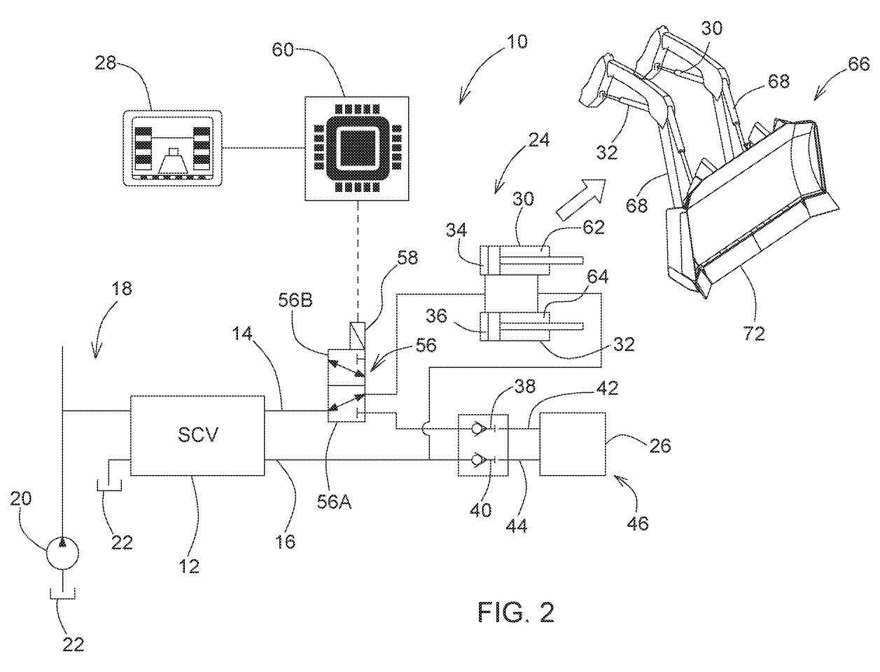

FIGS. 1 and 2 show different schematically illustrated designs of the arrangement according to the disclosure for operating a hydraulic control valve for an agricultural tractor.

The arrangement 10, which is located in an agricultural tractor (not explicitly shown), comprises a hydraulic control valve 12, which has a first or second hydraulic connection 14, 16 alternately acting as a feed line or return line for hydraulic fluid depending on an operating command. The hydraulic control valve 12 is incorporated into a hydraulic system 18 of the agricultural tractor, which is illustrated in FIG. 1 by a high-pressure pump 20 and a reservoir 22 for hydraulic fluid.

The hydraulic control valve 12 is only one of a plurality of hydraulic control valves or SCVs (Selective Control Valves), which are assembled in a control valve block in the rear and/or front area of the agricultural tractor and enable a supply to greatly varying hydraulic consumers (not shown). The hydraulic consumers connected to the control valve block are, for example, part of an attachment or auxiliary device attachable to the agricultural tractor and are used there to execute operating and/or working functions specific for the relevant attachment or auxiliary device.

The hydraulic control valve 12 depicted differs from the above, however, in that it is used to operate hydraulic consumers 24, 26 which are independent of one another.

To put the respective hydraulic consumer 24, 26 into operation, the valve position of the hydraulic control valve 12 can be set by an operator via an operator terminal 28 provided in the agricultural tractor.

A first hydraulic consumer 24 is the first and second hydraulic cylinder 30, 32 (spatially) associated with the agricultural tractor, having first and second working or piston chambers 34, 36 connected in parallel; a second hydraulic consumer 26 is connectable or connected to a first and second hydraulic coupler 38, 40 for the purpose of its operation. The hydraulic couplers 38, 40 are designed as self-locking hydraulic sockets for receiving complementary hydraulic plugs, which are connected to the second hydraulic consumer 26 via respective hydraulic hoses 42, 44.

According to the example, the second hydraulic consumer 26 is used to execute a hydraulic function of an attachment or auxiliary device 46 (not specified in more detail here), which is attached to the agricultural tractor. The second hydraulic consumer 26 is typically designed here as a hydraulic motor or hydraulic actuator.

According to the first design of the arrangement 10 shown in FIG. 1, it is provided that the two hydraulic cylinders 30, 32 are designed as single-action. In the present case, the hydraulic cylinders 30, 32 are part of a hydraulic lifting mechanism 48 of a front power lifter 50 of the agricultural tractor and are used there to raise and lower associated lower links 52, 54. Notwithstanding the illustration in FIG. 1, the two working chambers 34, 36 can also be ring chambers of the hydraulic cylinders 30, 32 instead of piston chambers. To avoid outgassing of the hydraulic fluid caused by negative pressure, the selection of the working chambers 34, 36 takes place such that a compressive load acts thereon in the inactive state.

Furthermore, the arrangement 10 comprises a 3/2-way valve 56, by means of which the first hydraulic connection 14 can be connected either to the piston chambers 34, 36 of the two hydraulic cylinders 30, 32 or to the first hydraulic coupler 38. The second hydraulic connection 16, in contrast, is directly connected to the second hydraulic coupler 40.

The 3/2-way valve 56 can be moved into two different switching positions 56A and 56B. In the first switching position 56A (see FIG. 1), a hydraulic connection is established between the first hydraulic connection 14 and the piston chambers 34, 36 of the two hydraulic cylinders 30, 32; this connection is blocked in the direction of the first hydraulic coupler 38. If the 3/2-way valve 56 is in the second switching position 56B, the hydraulic connection between the first hydraulic connection 14 and the piston chambers 34, 36 of the two hydraulic cylinders 30, 32 is blocked, whereas it is released with respect to the first hydraulic coupler 38. In this state, the two hydraulic cylinders 30, 32 are then blocked with respect to movement (with interruption of the hydraulic connection thus established) due to the hydraulic fluid enclosed in the piston chambers 34, 36. The two hydraulic cylinders 30, 32 therefore adopt an inactive state, in which exclusively an actuation of the second hydraulic consumer 26 is released.

To enable a convenient selection between the two switching positions 56A and 56B and thus the two hydraulic consumers 24, 26 via the operator terminal 28 located in a driver's platform of the agricultural tractor, it is provided that the 3/2-way valve 56 is designed to be electrically actuable by means of an electromagnetic positioning element 58 at the behest of a supervision unit 60 connected to the operator terminal 28. In a modification of the arrangement 10 (not shown), the 3/2-way valve 56 can also be designed as mechanically actuable and can have means for manual actuation in the form of an operating lever or the like.

FIG. 2 shows a second design of the arrangement 10, which represents a modification of the first design shown in FIG. 1 insofar as the two hydraulic cylinders 30, 32 are designed as double-action. The hydraulic cylinders 30, 32 have first and second further working chambers or ring chambers 62, 64 connected in parallel, which are connected directly to the second hydraulic connection 16. The hydraulic cylinders 30, 32 are in the present case part of a front loader 66 attached to the agricultural tractor and are used therein for adjusting a loader arm 68 or alternatively also a loading tool 70 in the form of a loading scoop 72.

In addition, it is to be noted that the illustration of two hydraulic cylinders 30, 32 in each case as well as the described use in a front power lifter 50 or front loader 66 is to be understood solely as an example. Rather, it can also involve any other number or use.

A deviating interconnection of the two hydraulic cylinders 30, 32 can also be provided, in which the working chambers 34, 36 are designed as ring chambers and the further working chambers 62, 64 are designed as piston chambers. Such an interconnection is to be selected if a pulling load acts on the hydraulic cylinders 30, 32 in the inactive state (see in this regard also the above remark in conjunction with the use of single-action hydraulic cylinders 30, 32).

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. An arrangement for operating a hydraulic control valve for an agricultural tractor, comprising:
a first hydraulic connection and a second hydraulic connection of the hydraulic control valve alternately acting as a feed line or return line for hydraulic fluid depending on an operating command;
a first and second hydraulic coupler for operating a hydraulic consumer attachable thereon; and
a 3/2-way valve selectively connects the first hydraulic connection to a working chamber of a hydraulic cylinder in a first switching position and to the first hydraulic coupler in a second switching position;
wherein the second hydraulic connection is connected directly to the second hydraulic coupler.

2. The arrangement of claim 1, wherein the hydraulic cylinder is designed as single-action.

3. The arrangement of claim 2, wherein the hydraulic cylinder is part of a hydraulic lifting mechanism of a front power lifter.

4. The arrangement of claim 1, wherein the hydraulic cylinder is designed as double-action, and wherein a further working chamber of the hydraulic cylinder is directly connected to the second hydraulic connection.

5. The arrangement of claim 4, wherein the hydraulic cylinder is part of a front loader.

6. The arrangement of claim 1, wherein the 3/2-way valve is designed as electrically actuable.

7. The arrangement of claim 1, wherein the 3/2-way valve is designed as mechanically actuable.

8. An agricultural tractor comprising the arrangement of claim 1.

9. A hydraulic system of an agricultural tractor, comprising:
a hydraulic control valve having a first hydraulic connection and a second hydraulic connection alternately acting as a feed line or return line for hydraulic fluid depending on an operating command;
a first and second hydraulic coupler for operating a hydraulic consumer attachable thereon; and
a 3/2-way valve selectively connects the first hydraulic connection to a working chamber of a hydraulic cylinder in a first switching position and to the first hydraulic coupler in a second switching position;
wherein the second hydraulic connection is connected directly to the second hydraulic coupler.

10. The hydraulic system of claim 9, wherein the hydraulic cylinder is designed as single-action.

11. The hydraulic system of claim 10, wherein the hydraulic cylinder is part of a hydraulic lifting mechanism of a front power lifter.

12. The hydraulic system of claim 9, wherein the hydraulic cylinder is designed as double-action, and wherein a further working chamber of the hydraulic cylinder is directly connected to the second hydraulic connection.

13. The hydraulic system of claim 12, wherein the hydraulic cylinder is part of a front loader.

14. The hydraulic system of claim 9, wherein the 3/2-way valve is designed as electrically actuable.

15. The hydraulic system of claim 9, wherein the 3/2-way valve is designed as mechanically actuable.
